(19) United States
(12) Patent Application Publication
(10) Pub. No.: US 2022/0390040 A1
(43) Pub. Date: Dec. 8, 2022

(54) FLANGED PIPE SUPPORT BRACKET

(71) Applicant: Patrick Harold Dutton, Carr, CO (US)

(72) Inventor: Patrick Harold Dutton, Carr, CO (US)

(21) Appl. No.: 17/303,812

(22) Filed: Jun. 8, 2021

(51) Int. Cl. F16L 3/02

(52) U.S. Cl. CPC F16L 3/02

(57) ABSTRACT

A unitary steel bracket has an arced portion and a hanger appendage extending perpendicularly from a convex perimeter of the arced portion. The arced portion has two opposed planar surfaces with parallel mount holes through each end. The hanger appendage has two opposed planar surfaces coplanar with the arced portion planar surfaces. A portion of the hanger appendage is bent at a 90-degree angle and has a support mount hole perpendicular to the parallel mount holes. the bracket is prefabricated to a predetermined bracket size corresponding to a predetermined pipe flange size. A method of hanging joined flanged includes providing the bracket; aligning the parallel mount holes with holes on a pipe flange; inserting connection bolts through the holes; threading nuts onto the bolts to a predetermined torque; and attaching the support mount hole to a building structure.

### BACKGROUND OF THE INVENTION

The present invention relates to mechanical piping supports for flanged piping and, more particularly, to a bracket therefor.

Hanging and supporting flanged piping systems is difficult and the piping systems are time consuming to service. Serviceability is cumbersome and can be unsafe. Current mechanical piping supports for flanged piping are fabricated manually on the job site, which is labor intensive and time consuming. Moreover, manually fabricated hangers are not accurate nor consistent in dimension or style.

As can be seen, there is a need for a prefabricated piping support that is consistent, accurate, and safe, making piping systems faster and easier to service.

### SUMMARY OF THE INVENTION

In one aspect of the present invention, a unitary steel bracket operative to support flanged pipes is provided, comprising: an arced portion having two opposed substantially planar surfaces with parallel mount holes therethrough at each end thereof; a hanger appendage extending perpendicularly from a convex perimeter of the arced portion, said hanger appendage having two opposed substantially planar surfaces coplanar with the opposed substantially planar surfaces of the arced portion; wherein a portion of the hanger appendage is bent at a 90-degree angle with a support mount hole formed through the portion, said support mount hole being perpendicular to the parallel mount holes; and wherein the bracket is prefabricated to a predetermined bracket size corresponding to a predetermined pipe flange size.

In another aspect of the present invention, a method of hanging joined flanged pipes is provided, comprising providing the unitary steel bracket; aligning the parallel mount holes with holes on a pipe flange; inserting connection bolts through the parallel mount holes and the pipe flange holes; threading nuts onto the connection bolts to a predetermined torque; inserting an attachment component through the support mount hole; and attaching the attachment component to a building structure.

These and other features, aspects and advantages of the present invention will become better understood with reference to the following drawings, description, and claims.

### BRIEF DESCRIPTION OF THE DRAWINGS

FIG. 1 is a perspective view of a flanged pipe support bracket according to an embodiment of the present invention, shown in use;

FIG. 2 is another perspective view thereof;

FIG. 3 is an exploded view thereof;

FIG. 4 is a sectional view thereof, taken along line 4-4 in FIG. 1; and

FIG. 5 is a perspective view thereof, showing an alternate mounting.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a unitary steel bracket operative to support flanged pipes. The bracket is prefabricated to a predetermined flange size with a hanger appendage having a bent portion bent at a 90-degree angle.

The inventive bracket utilizes the existing bolts of a flanged pipe connection to support the section. The inventive bracket is a quick, serviceable, and safe means to hang flanged pipe and fittings. It reduces labor time, increases productivity, and improves serviceability and safety of future repairs, e.g., when the connection or fitting needs to be removed from the piping system.

The inventive flange may be used as follows. When assembling flanged piping components, the large holes in the hanging bracket may be lined up with the holes on the flange. Connection bolts may be inserted through the bracket and flanges. Nuts may be threaded onto the bolts and torqued according to the manufacturer's specs. The upper hole of the bracket may connect the bracket to the building structure using means known in the plumbing industry, such as a threaded rod inserted through a corresponding aligned hole in the building structure.

In some embodiments, an adjustable riser plate with slots and bolts may be provided in case a piping component needs to be installed in a specific angle or location.

In some embodiments, a support gusset may be welded onto the brackets to safely support heavier material.

The bracket is generally manufactured from steel and is otherwise not particularly limited. The bracket may be manufactured, for example, from ¼″ A30 plate steel or ¼″ A36 hot rolled steel.

The inventive bracket may be cut to a predetermined size using a computer numerical control (CNC) plasma table. A press break may be used to bend a 90-degree angle in the bracket to provide a hanger connection point to a building's structure.

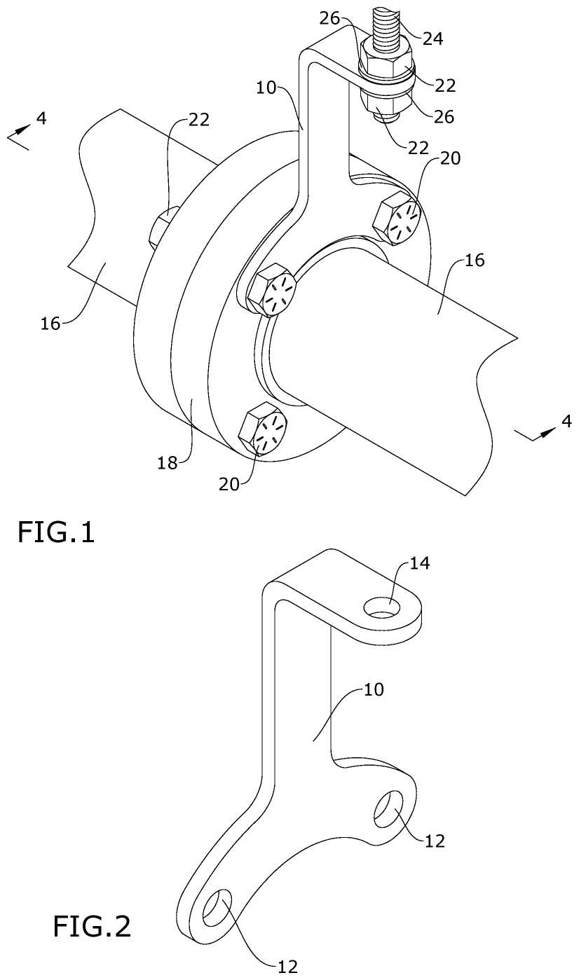

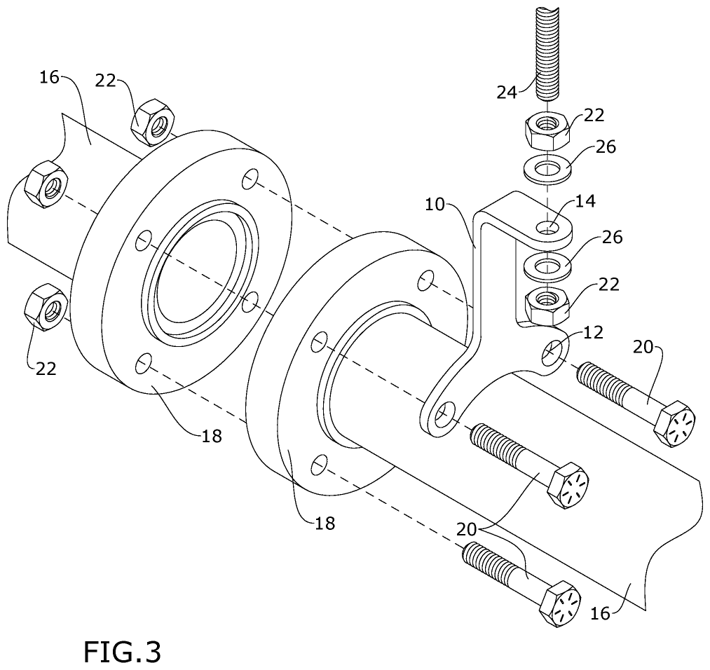

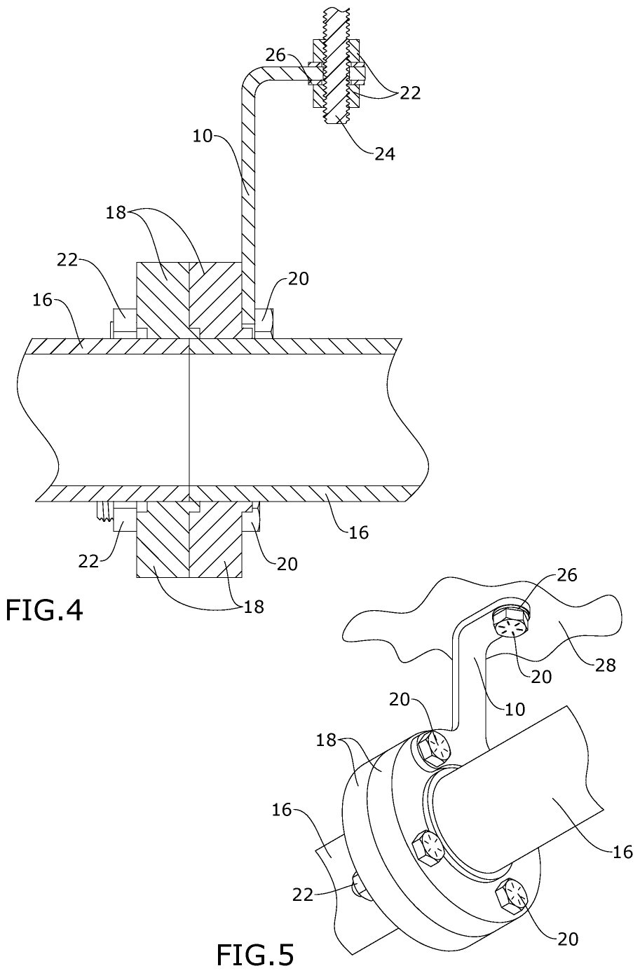

Referring to FIGS. 1 through 5, FIG. 2 shows a bracket 10 according to an embodiment of the present invention having a straight portion extending perpendicularly from the perimeter of a flattened arced portion which has pipe flange mount holes 12 at each rounded end. The opposite end of the straight portion is bent at a 90° angle perpendicular to a flattened face of the arced portion, with a support mount hole 14 formed at the rounded end. As shown in FIG. 1, bolts 20 passed through the pipe flange mount holes 12 secure the bracket 10 to the flanges 18 of a coupled pair of pipes 16. A threaded rod 24 passed through the support mount hole may be secured in place on both ends with nuts 22 and washers 26, as shown in FIGS. 1, 3, and 4. Alternatively, the bracket 10 may be bolted 20 to a solid mount 28, as seen in FIG. 5. A washer 26 may be placed between the bolt 20 and the bracket 10 around the support mount hole 14.

It should be understood, of course, that the foregoing relates to exemplary embodiments of the invention and that modifications may be made without departing from the spirit and scope of the invention as set forth in the following claims.

What is claimed is:

1. A unitary steel bracket operative to support flanged pipes, comprising:
an arced portion having two opposed substantially planar surfaces with parallel mount holes therethrough at each end thereof;
a hanger appendage extending perpendicularly from a convex perimeter of the arced portion, said hanger appendage having two opposed substantially planar surfaces coplanar with the opposed substantially planar surfaces of the arced portion;
wherein a portion of the hanger appendage is bent at a 90-degree angle with a support mount hole formed through the portion, said support mount hole being perpendicular to the parallel mount holes; and
wherein the bracket is prefabricated to a predetermined bracket size corresponding to a predetermined pipe flange size.

2. The unitary steel bracket of claim 1, wherein each end of the arced portion is rounded.

3. The unitary steel bracket of claim 1, wherein an end of the bent portion of the hanger appendage is rounded.

4. The unitary steel bracket of claim 1, wherein the parallel mount holes align with holes on a pipe flange.

5. The unitary steel bracket of claim 1, wherein the support mount hole aligns with a corresponding hole on a building structure.

6. A method of hanging joined flanged pipes, comprising:
a) providing a unitary steel bracket, comprising:
i. an arced portion having two opposed substantially planar surfaces with parallel mount holes therethrough at each end thereof;
ii. a hanger appendage extending perpendicularly from a convex perimeter of the arced portion, said hanger appendage having two opposed substantially planar surfaces coplanar with the opposed substantially planar surfaces of the arced portion;
iii. wherein a portion of the hanger appendage is bent at a 90-degree angle with a support mount hole formed through the portion, said support mount hole being perpendicular to the parallel mount holes; and
iv. wherein the bracket is prefabricated to a predetermined bracket size corresponding to a predetermined pipe flange size;
b) aligning the parallel mount holes with holes on a pipe flange;
c) inserting connection bolts through the parallel mount holes and the pipe flange holes;
d) threading nuts onto the connection bolts to a predetermined torque;
e) inserting an attachment component through the support mount hole; and
f) attaching the attachment component to a building structure.
